(19) United States
(12) Patent Application Publication
(10) Pub. No.: US 2025/0100425 A1
(43) Pub. Date: Mar. 27, 2025

(54) AUTOMATED SWIVEL SEAT AND CONTROL METHOD THEREOF

(71) Applicant: GUMCHANG CO., LTD., Yeongcheon-si (KR)

(72) Inventors: Jae Yel Song, Daegu (KR); Hai Tai Choi, Daegu (KR); Chae Sung Song, Daegu (KR); Se Gil Shin, Daegu (KR); Sang Ho Lee, Daegu (KR); Man Gi Lee, Pohang-si (KR); Yong Choi, Ulsan (KR)

(21) Appl. No.: 18/523,813

(22) Filed: Nov. 29, 2023

(30) Foreign Application Priority Data
Sep. 26, 2023 (KR) 10-2023-0129740

(51) Int. Cl. B60N 2/02

(52) U.S. Cl. CPC B60N 2/02253; B60N 2/0244

(57) ABSTRACT

Automated swivel seat and control method thereof are provided. Automated swivel seat comprising a base part fixed to a lower frame of the vehicle and comprising a first through hole formed in a central part thereof, a seat support part fixed to a lower side of a seat frame and configured to rotate on the base part, a swivel structure disposed between the base part and the seat support part and comprising an upper swivel plate coupled to the seat support part and a lower coupling plate coupled to the base part, a first gear coupled to one side of the upper swivel plate, a second gear engage with the first gear, a motor part configured to provide power to the second gear, a sensor part configured to generate gear measurement values comprising a rotation direction and a rotation angle of the seat support part.

### CROSS-REFERENCE TO RELATED APPLICATION

This application claims priority under 35 U.S.C § 119 to Korean Patent Application No. 10-2023-0129740, filed on Sep. 26, 2023, in the Korean Intellectual Property Office, the entire contents of which is hereby incorporated by reference.

### TECHNICAL FIELD

The disclosure relates to an automated swivel seat and a control method thereof. More particularly, the disclosure relates to an automated swivel seat that is provided with power, automatically rotates, and repositions itself, and a method for controlling the same.

### BACKGROUND

The contents set forth in this section simply provide background information on the present embodiments and do not constitute prior art.

In general, a vehicle is a means that helps passengers get to their destination as a means of transportation.

With recent advances in battery and autonomous vehicle technology, vehicles are expected to provide more than just a means of transportation for their passengers. For example, as the technology for high-power batteries installed in electric vehicles advances, vehicles are now equipped with an environment in which they can supply electricity that can be used for purposes other than the electricity needed for driving. Through this, passengers can engage in other activities utilizing electricity inside the vehicle other than driving.

In addition, with advances in autonomous driving technology, as vehicles take over the driving, passengers can perform tasks other than driving.

Accordingly, there is a growing need to swivel seats to make use of the space inside a vehicle.

However, typical vehicle seats are fixed to face in one direction so as not to be rotated for the driver to drive the vehicle. Seats were controlled only as seats that could move back and forth along guide rails within defined areas or adapt to the body of each user by operating parts of the seat frame separately.

Furthermore, seats in a vehicle may vary depending on their placement in the vehicle and surrounding electrical components. Therefore, there is a need for a swivelable seat that is not limited to its placement in the vehicle and surrounding electrical components and that is highly versatile.

In addition, there is a problem that seats in a vehicle are so heavy that it is not easy for a user him/herself to separate the seats from the vehicle and reposition them.

The description set forth in the background section should not be assumed to be prior art merely because it is set forth in the background section. The background section may describe aspects or embodiments of the disclosure.

This research was financially supported by the Ministry of Trade, Industry and Energy, Korea, under the “World Class 300 Project (R&D, Project number: P0012995)” supervised by the Korea Institute for Advancement of Technology (KIAT).

### SUMMARY

One aspect of the disclosure provides an automated swivel seat that operates to automatically rotate a seat installed inside a vehicle about a central axis, and a method for controlling the same.

Another aspect of the disclosure provides an automated swivel seat that is easy to install in a vehicle without being limited to placement in the vehicle and surrounding electrical components, and a method for controlling the same.

Other aspects of the disclosure provide an automated swivel seat that operates to automatically rotate about a central axis at a corresponding position even if a seat installed inside a vehicle is repositioned along guide rails, and a method for controlling the same.

Other aspects of the disclosure provide an automated swivel seat that can reduce noises generated according to rotation while increasing the gear efficiency of the automated swivel seat, and a method for controlling the same.

Other aspects of the disclosure provide an automated swivel seat that can extend the product life cycle of gears for rotating the automated swivel seat and can reduce maintenance costs, and a method for controlling the same.

Other aspects of the disclosure provide an automated swivel seat that repositions the seat by controlling power to reach a rotation target value through monitoring for the seat rotation, and a method for controlling the same.

Other aspects of the disclosure provide an automated swivel seat that detects errors by monitoring the seat rotation and controls the rotation motion based thereon, and a method for controlling the same.

According to some aspects of the disclosure, automated swivel seat includes a base part fixed to a lower frame of the vehicle and comprising a first through hole formed in a central part thereof, a seat support part fixed to a lower side of a seat frame and configured to rotate on the base part, a swivel structure disposed between the base part and the seat support part and comprising an upper swivel plate coupled to the seat support part and a lower coupling plate coupled to the base part, a first gear disposed in the first through hole and coupled to one side of the upper swivel plate, a second gear engage with the first gear, a motor part fixed to the base part, and coupled to the second gear and configured to provide power to the second gear, a sensor part coupled onto the swivel structure and configured to generate gear measurement values comprising a rotation direction and a rotation angle of the seat support part and a control part configured to control operation of the motor part by comparing the gear measurement values and rotation target values.

According to some aspects, wherein the first gear moves along an outer peripheral surface of the second gear as the motor part operates, and the upper swivel plate rotates in proportion to the number of revolutions of the first gear.

According to some aspects, wherein the first gear has one side thereof formed to engage with the outer peripheral surface of the second gear, and a stepped part formed so that the other side thereof passes through the first through hole.

According to some aspects, wherein the sensor part comprises a first sensor module coupled to the upper swivel plate and configured to measure the rotation angle of the upper swivel plate and at least one second sensor module coupled to the lower coupling plate and configured to measure the rotation direction of the upper swivel plate by measuring a change in position of the first sensor module.

According to some aspects, wherein the rotation target values are determined based on at least one value that is preset so that the first sensor module is disposed in correspondence to one of the second sensor modules.

According to some aspects, wherein the control part calculates an error between the gear measurement values and the rotation target values, and controls the operation of the motor part based on a difference between the error and a preset reference value.

According to some aspects, wherein the control part comprises generating error data based on whether the gear measurement values change and whether the power is provided if the error is greater than the preset reference value and updating the rotation target values based on the error data.

According to some aspects, wherein the rotation target values are determined by user input entered via an interface part.

According to some aspects, further comprising a guide rail part coupled to the lower frame, a sliding part configured to slide on the guide rail part and a sliding structure comprising a sliding motor part coupled to the guide rail part and configured to provide power to the sliding part, wherein the base part is coupled to the sliding part.

According to some aspects of the disclosure, a method of controlling the automated swivel seat includes receiving user input entered via an interface part that is linked with the control part, deriving rotation target values comprising a target rotation direction and a target rotation angle based on the user input, operating a motor part configured to provide power to a second gear engage with a first gear fixed onto a seat support part, wherein the seat support part is fixed to a seat frame, measuring a rotation direction and a rotation angle of the seat support part by a sensor part, and receiving gear measurement values comprising the measured rotation direction and rotation angle and controlling operation of the motor part based on the gear measurement values and the rotation target values.

According to some aspects, wherein the controlling the operation of the motor part comprises, calculating an error between the gear measurement values and the rotation target values and stopping the operation of the motor part if the error is smaller than a preset reference value.

According to some aspects, wherein the controlling the operation of the motor part further comprises generating error data based on whether the gear measurement values change and whether the power is provided if the error is greater than the preset reference value and updating the rotation target values based on the error data.

Aspects of the disclosure are not limited to those mentioned above, and other objects and advantages of the disclosure that have not been mentioned can be understood by the following description and will be more clearly understood by embodiments of the disclosure. In addition, it will be readily understood that the objects and advantages of the disclosure can be realized by the means and combinations thereof set forth in the claims.

The automated swivel seat and the method for controlling the same of the present disclosure can increase the utilization of space inside the vehicle by allowing the rotation direction of the seat to be freely adjusted inside the vehicle.

In addition, the present disclosure can be easily installed on an existing vehicle frame without being limited to placement within a vehicle and can be applied to other fields besides vehicles, thereby having high versatility by being able to be installed on the guide rails fixed to the vehicle lower frame or on the vehicle lower frame.

Further, the present disclosure can be highly scalable for seat placement by allowing a seat to be rotated automatically about the central axis at the corresponding position even if the seat is repositioned along the guide rails, and the utilization of space inside the vehicle can be improved through the reposition of the seats within the vehicle.

Moreover, the present disclosure can provide the user with the convenience of being able to freely adjust the rotation direction of the seat intuitively inside the vehicle by providing the user with a control scheme that corresponds to a common user experience and a logical way of thinking with which the user repositions the vehicle seats.

Furthermore, the present disclosure can reposition the seat to reach the rotation target value by controlling the power, and can improve the ease of seat control by providing the user with an interface through which the rotation target value can be inputted.

In addition, the present disclosure can improve the convenience of vehicle maintenance by providing the user with errors detected by monitoring the rotation of the automated swivel seat. Moreover, by controlling the operation of the automated swivel seat based on the detected errors, it is possible to prevent phenomena that errors occur in the seat operation or of non-rotation.

Furthermore, the present disclosure can reduce noises caused by seat rotation, power transmission and load are distributed as the contact areas of the gears for rotation are enlarged and the efficiency of the gears is increased, thereby extending the product life cycle of the gears, and maintenance costs associated therewith can be reduced.

In addition to the contents described above, specific effects of the present disclosure will be described together while describing the following specific details for carrying out the present disclosure.

In addition to the foregoing, the specific effects of the disclosure will be described together while elucidating the specific details for carrying out the embodiments below.

### BRIEF DESCRIPTION OF THE DRAWINGS

FIG. 1 is a perspective view of an automated swivel seat in accordance with some embodiments of the present disclosure.

FIG. 2 is a front view and a rear view of the automated swivel seat of FIG. 1.

FIG. 3 is a right side view and a left side view of the automated swivel seat of FIG. 1.

FIG. 4 is a plan view and a bottom view of the automated swivel seat of FIG. 1.

FIG. 5 is an enlarged perspective view of a portion of the automated swivel seat of FIG. 1.

FIG. 6 is a perspective view for describing a portion of the automated swivel seat disposed on one side of the seat frame of FIG. 1.

FIG. 7 is a cross-sectional view of the seat support part, the swivel structure, the base part, and the first gear taken along line A-A′ of FIG. 6.

FIG. 8 is an exploded perspective view of the portion of the automated swivel seat of FIG. 6.

FIG. 9 is a front view and a rear view of the portion of the automated swivel seat of FIG. 6.

FIG. 10 is a right side view and a left side view of the portion of the automated swivel seat of FIG. 6.

FIG. 11 is a plan view and a bottom view of the portion of the automated swivel seat of FIG. 6.

FIG. 12 is a diagram for describing the arrangement of the first and second gears and the motor part of the portion of the automated swivel seat of FIG. 6.

FIG. 13 is a diagram for describing the operation of the first gear and the second gear according to the operation of the motor part of FIG. 6.

FIG. 14 is a block diagram of an automated swivel seat for describing a method of controlling the automated swivel seat in accordance with some embodiments of the present disclosure.

FIG. 15 is a flowchart for describing a method of controlling an automated swivel seat in accordance with a first embodiment of the present disclosure.

FIG. 16 is a flowchart for describing a method of controlling an automated swivel seat in accordance with a second embodiment of the present disclosure.

FIG. 17 is a flowchart for describing a method of controlling an automated swivel seat in accordance with a third embodiment of the present disclosure.

FIG. 18 is a flowchart for describing a method of controlling an automated swivel seat in accordance with a fourth embodiment of the present disclosure.

### DETAILED DESCRIPTION OF THE PREFERRED EMBODIMENTS

The terms or words used in the disclosure and the claims should not be construed as limited to their ordinary or lexical meanings. They should be construed as the meaning and concept in line with the technical idea of the disclosure based on the principle that the inventor can define the concept of terms or words in order to describe his/her own embodiments in the best possible way. Further, since the embodiment described herein and the configurations illustrated in the drawings are merely one embodiment in which the disclosure is realized and do not represent all the technical ideas of the disclosure, it should be understood that there may be various equivalents, variations, and applicable examples that can replace them at the time of filing this application.

Although terms such as first, second, A, B, etc. used in the description and the claims may be used to describe various components, the components should not be limited by these terms. These terms are used only for the purpose of distinguishing one component from another. For example, a first component may be referred to as a second component, and similarly, a second component may be referred to as a first component, without departing from the scope of the disclosure. The term ‘and/or’ includes a combination of a plurality of related listed items or any item of the plurality of related listed items.

The terms used in the description and the claims are merely used to describe particular embodiments and are not intended to limit the disclosure. Singular expressions include plural expressions unless the context explicitly indicates otherwise. In the application, terms such as “comprise,” “have,” “include”, “contain,” etc. should be understood as not precluding the possibility of existence or addition of features, numbers, steps, operations, components, parts, or combinations thereof described herein. Terms such as a “circuit” or “circuitry”, refers to a circuit in hardware but may also refer to a circuit in software.

Unless otherwise defined, the phrases “A, B, or C,” “at least one of A, B, or C,” or “at least one of A, B, and C” may refer to only A, only B, only C, both A and B, both A and C, both B and C, all of A, B, and C, or any combination thereof.

Unless otherwise defined, all terms used herein, including technical or scientific terms, have the same meaning as commonly understood by those of ordinary skill in the art to which the disclosure pertains.

Terms such as those defined in commonly used dictionaries should be construed as having a meaning consistent with the meaning in the context of the relevant art, and are not to be construed in an ideal or excessively formal sense unless explicitly defined in the disclosure.

In addition, each configuration, procedure, process, method, or the like included in each embodiment of the disclosure may be shared to the extent that they are not technically contradictory to each other.

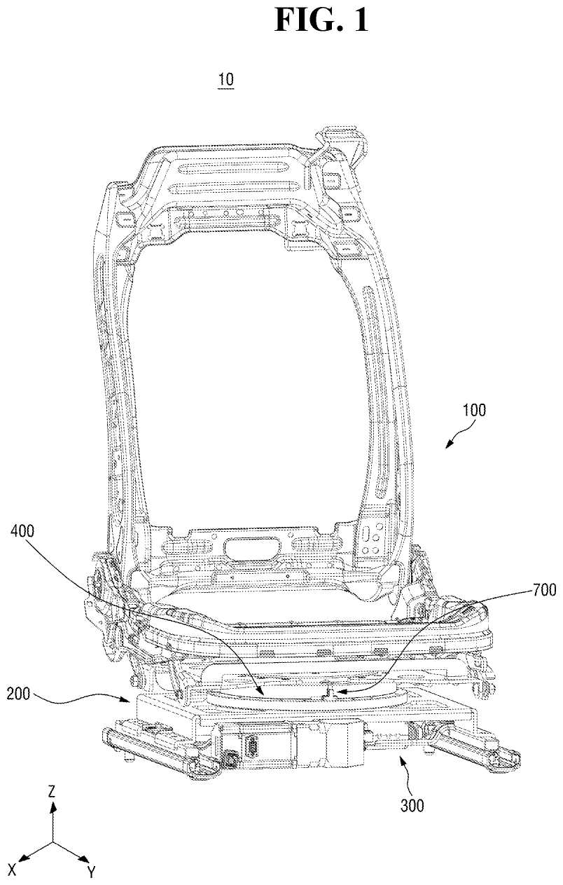

Hereinafter, an automated swivel seat and a method for controlling the same in accordance with some embodiments of the present disclosure will be described in detail with reference to FIGS. 1 to 18.

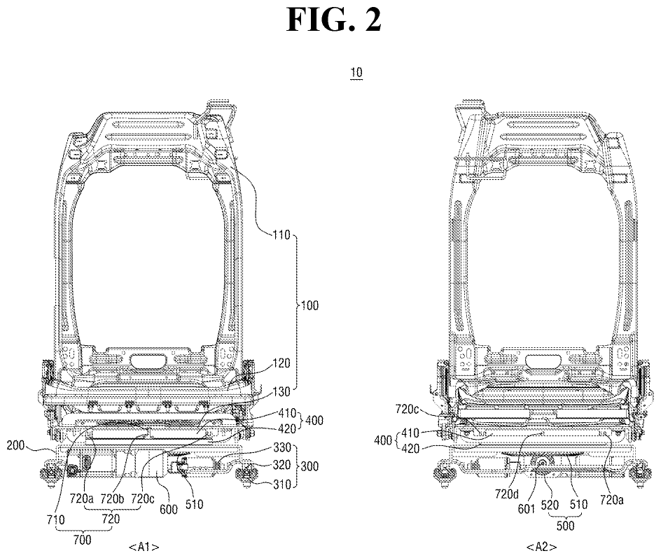

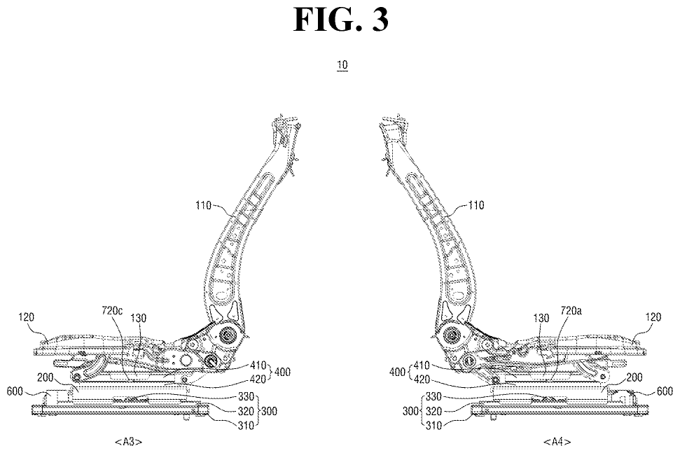

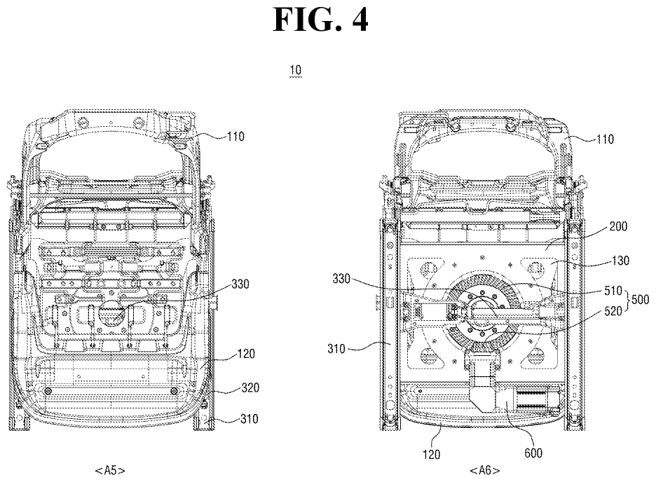

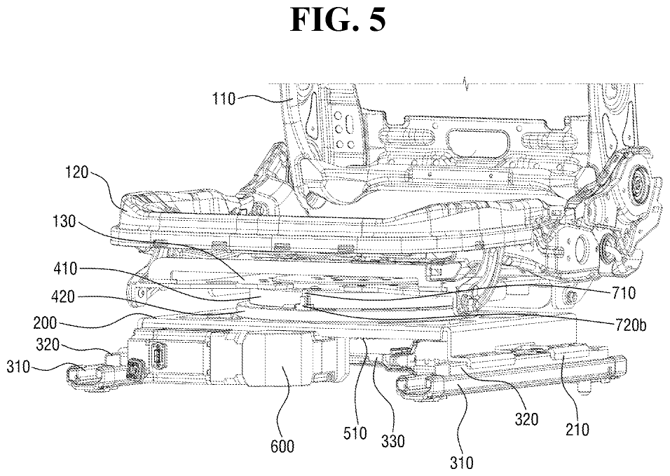

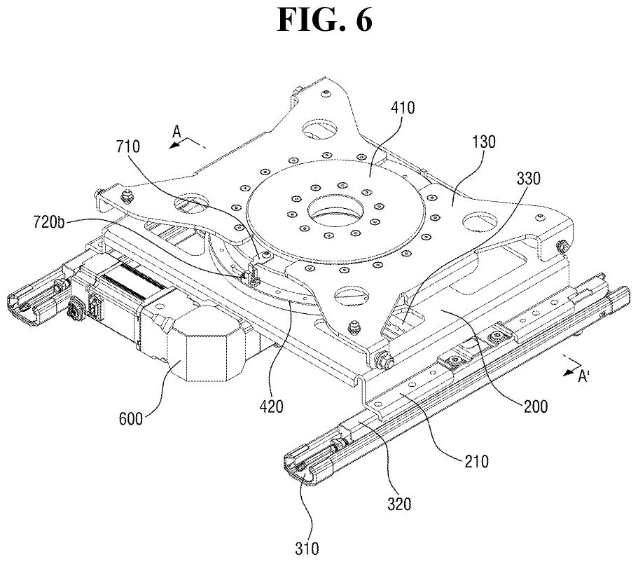

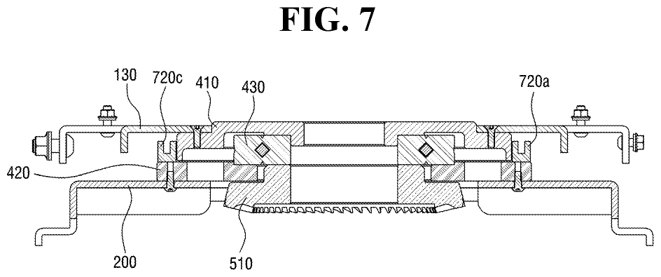

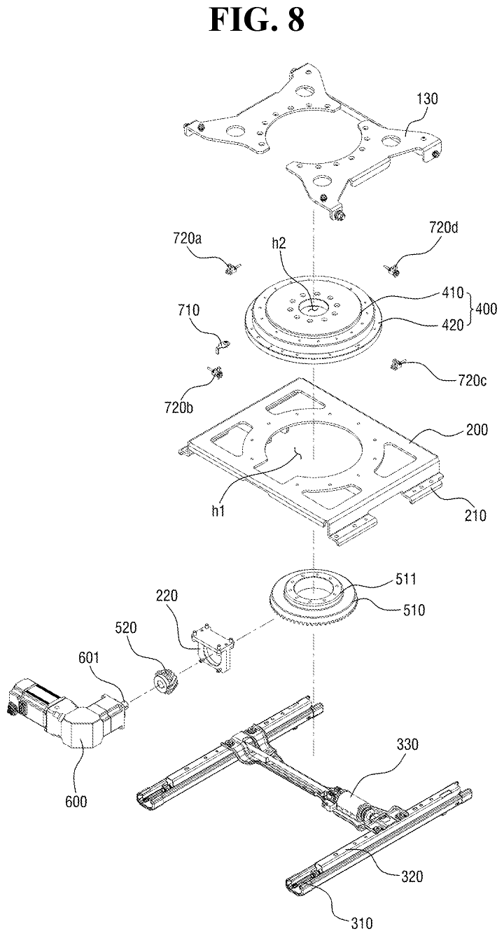

FIG. 1 is a perspective view of an automated swivel seat in accordance with some embodiments of the present disclosure. FIG. 2 is a front view and a rear view of the automated swivel seat of FIG. 1. FIG. 3 is a right side view and a left side view of the automated swivel seat of FIG. 1. FIG. 4 is a plan view and a bottom view of the automated swivel seat of FIG. 1. FIG. 5 is an enlarged perspective view of a portion of the automated swivel seat of FIG. 1. FIG. 6 is a perspective view for describing a portion of the automated swivel seat disposed on one side of the seat frame of FIG. 1. FIG. 7 is a cross-sectional view of the seat support part, the swivel structure, the base part, and the first gear taken along line A-A′ of FIG. 6. FIG. 8 is an exploded perspective view of the portion of the automated swivel seat of FIG. 6.

Referring to FIGS. 1 to 8, the automated swivel seat 10 may include a seat support part 130, a base part 200, a sliding structure 300, a swivel structure 400, a gear part 500, a motor part 600, and a sensor part 700.

The seat support part 130 may be fixed to a lower side of a seat frame 100 installed in a vehicle using at least one connecting member. Through this, the seat frame 100 can rotate along in dependence on the rotation of the seat support part 130. The seat support part 130 may be coupled with components of the automated swivel seat 10 that allow the seat frame 100 installed in the vehicle to rotate. For example, the seat support part 130 may be coupled with the swivel structure 400 and rotate together in dependence on the rotation of the swivel structure 400. The organic relationship and rotation motion of the seat support part 130 and the swivel structure 400 will be described later along with the swivel structure 400 with reference to FIGS. 6 and 7.

The seat frame 100 may include a back frame 110 and a bottom frame 120. The back frame 110 is a frame that forms a seat backrest, and may be formed by being extended upward based on the z-axis and y-axis. For example, the back frame 110 may be formed to correspond to the spinal flexion of a user. However, this description is merely illustrative, and embodiments of the present disclosure are not limited thereto.

The bottom frame 120 may be coupled with one end of the back frame 110 and form a seat bottom on which a user can be seated. Through this, the user can sit on the bottom frame 120 and lean his/her waist against the back frame 110.

The base part 200 may be fixed to a lower frame of the vehicle and include a first through hole h1 formed in the central portion thereof. For example, the base part 200 may be coupled with the sliding structure 300 coupled to the lower frame and repositioned by the motion of the sliding structure 300. Through this, the automated swivel seat 10 can automatically rotate based on the repositioned position of the base part 200 and the central axis of the automated swivel seat 10. Here, the central axis may be an axis formed in a direction passing through the center of the first through hole h1.

Further, the base part 200 may be fixed to a portion of the vehicle lower frame in addition to the sliding structure 300. For example, the base part 200 may be fixed to a portion of a region within a space where a passenger can sit inside the vehicle. Through this, the automated swivel seat 10 is not limited to the placement within the vehicle and can be easily installed on an existing vehicle frame, thereby providing high versatility.

Moreover, the base part 200 may include a bracket 220 having a hole formed between the base part 200 and the lower frame. For example, the bracket 220 may be formed by having one side of the base part 200 extended. The bracket 220 may be coupled with the motor part 600 and fix the motor part 600 to the base part 200. The organic relationship of the bracket 220, the gear part 500, and the motor part 600 will be described later along with the motor part 600.

The sliding structure 300 may include a guide rail part 310, a sliding part 320, and a sliding motor part 330. The guide rail part 310 may be coupled to the lower frame of the vehicle. For example, the guide rail part 310 may include a plurality of guide rails formed by extending along the surface of the lower frame based on the y-axis.

In addition, the sliding part 320 may be repositioned by sliding on the guide rail part 310. For example, the sliding part 32 may be formed in a shape that can be coupled with the guide rail part 310 so as to slide on each guide rail of the guide rail part 310.

The sliding motor part 330 may be coupled to the guide rail part 310 and provide power to the sliding part 320. For example, the sliding motor part 330 may be coupled to each guide rail of the guide rail part 310. Further, the sliding motor part 330 may provide power to the sliding part 320 so that the sliding part 320 slides on each guide rail. When the sliding motor part 330 provides power to the sliding part 320, the sliding part 320 may move along the extended axis of each guide rail. At this time, the sliding part 320 may be disposed at the same location within each guide rail. However, this description is merely illustrative, and embodiments of the present disclosure are not limited thereto.

The swivel structure 400 may include an upper swivel plate 410, a lower coupling plate 420, and a bearing module 430. The upper swivel plate 410 may be coupled to the seat support part 130. For example, the upper swivel plate 410 may be disposed between the base part 200 and the seat support part 130 and coupled to the seat support part 130. The upper swivel plate 410 may rotate to cause the seat support part 130 to rotate.

The lower coupling plate 420 may be coupled to the base part 200. For example, the lower coupling plate 420 may be disposed between the upper swivel plate 410 and the base part 200 and coupled to the base part 200. Further, the lower coupling plate 420 may be fixed to the base part 200. The lower coupling plate 420 is not fixed to the upper swivel plate 410 and may thus be disposed to be independent of the rotation motion of the upper swivel plate 410.

The bearing module 430 may be disposed between the upper swivel plate 410 and the lower coupling plate 420 and connect the upper swivel plate 410 and the lower coupling plate 420, thereby causing them to rotate with each other. For example, the bearing module 430 may be a cross roller bearing in which rollers alternately cross each other at right angles between the inner and outer rings. However, this description is merely illustrative, and embodiments of the present disclosure are not limited thereto. The swivel structure 400 can improve rotation accuracy based on the bearing module 430, stably handle the load provided through the seat frame 100, and minimize noises generated by the seat rotation as the coefficient of friction is small.

Next, the gear part 500 will be described with reference to FIGS. 8 to 12 together.

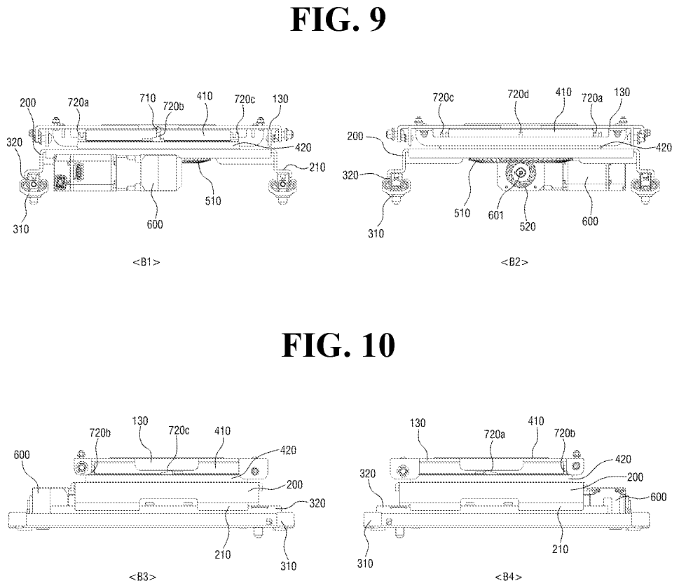

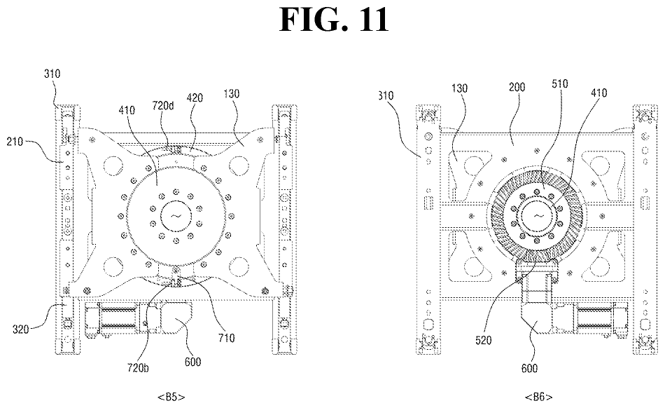

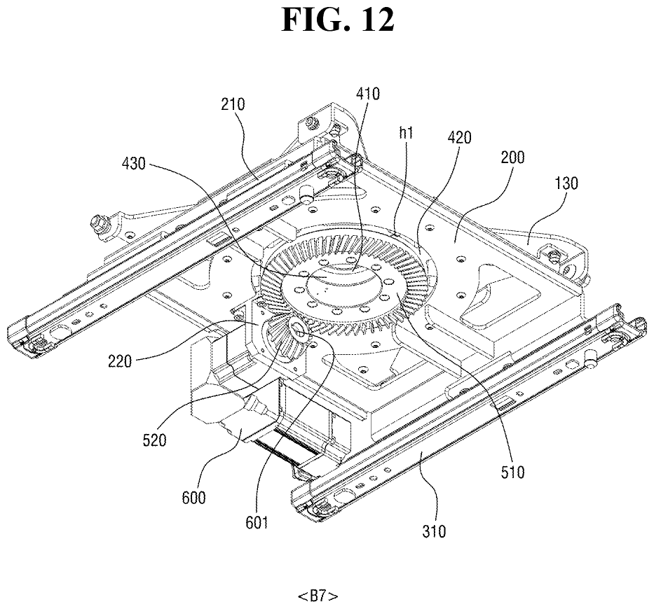

FIG. 9 is a front view and a rear view of the portion of the automated swivel seat of FIG. 6. FIG. 10 is a right side view and a left side view of the portion of the automated swivel seat of FIG. 6. FIG. 11 is a plan view and a bottom view of the portion of the automated swivel seat of FIG. 6. FIG. 12 is a diagram for describing the arrangement of the first and second gears and the motor part of the portion of the automated swivel seat of FIG. 6.

Referring to FIGS. 8 to 12 together, the gear part 500 may include a first gear 510 and a second gear 520. The first gear 510 and the second gear 520 may be meshed as a gear pair on intersecting axes.

The first gear 510 may be disposed in the first through hole h1 and coupled to one side of the upper swivel plate 410. For example, the first gear 510 may be disposed to pass through the first through hole h1 on one side of the base part 200 and coupled to one side of the upper swivel plate 410 based on the bearing module 430.

In addition, the first gear 510 may have one side thereof formed to engage with the outer peripheral surface of the second gear 520, and a stepped part 511 formed so that the other side thereof passes through the first through hole h1. At this time, the first gear 510 may be disposed so that the stepped part 511 is adjacent to the inner peripheral surface of the first through hole h1.

Further, the first gear 510 may be one of a straight bevel gear, a spiral bevel gear, and a zerol bevel gear. In order to reduce the rotational noise of the automated swivel seat 10 and extend the product life of the first gear 510, the first gear 510 may be a spiral bevel gear. However, this description is merely illustrative, and embodiments of the present disclosure are not limited thereto. The description is simply illustrative, and embodiments of the present disclosure are not limited thereto.

The second gear 520 may mesh with the first gear 510. For example, the second gear 520 may be disposed between the base part 200 and the lower frame and mesh with the first gear 510.

In addition, the second gear 520 may be coupled to the motor part 600 and provided with power. Through this, the first gear 510 can move along the outer peripheral surface of the second gear 520 according to the operation of the motor part 600. Therefore, the upper swivel plate 410 of the swivel structure 400 coupled to the first gear 510 can rotate in proportion to the number of revolutions of the first gear 510.

Referring to FIGS. 8 to 12, the motor part 600 may be coupled to the bracket 220 of the base part 200 and fixed to the base part 200. For example, the bracket 220 may be disposed between the motor part 600 and the second gear 520. The motor part 600 may pass through the bracket 220 and be coupled to the second gear 520.

The motor part 600 may be coupled to the second gear 520 and provide power to the second gear 520. To this end, the motor part 600 may include a shaft 601 to be coupled to the second gear 520. The second gear 520 may be coupled to the shaft 601 of the motor part 600 and provided with power.

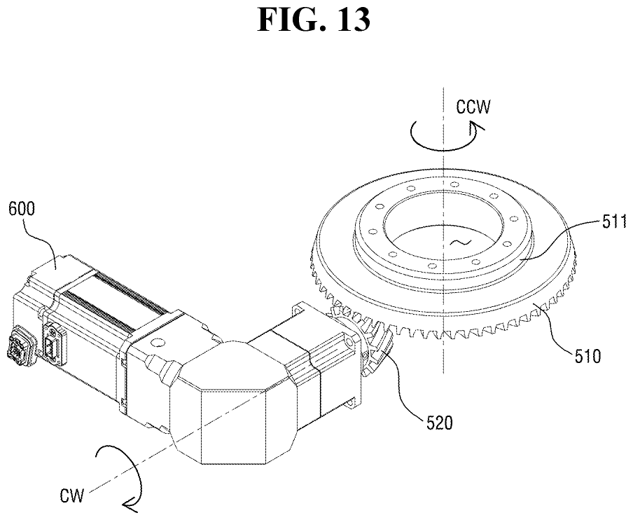

Referring to FIG. 13 together, the motor part 600 may provide power to the second gear 520 coupled to the shaft 601. If the second gear 520 that has been provided with power rotates clockwise (CW) about the central axis of the second gear 520, the first gear 510 can rotate counterclockwise (CCW) based on the central axis of the first gear 510. On the contrary, if the second gear 520 rotates counterclockwise (CCW) about the central axis of the second gear 520, the first gear 510 can rotate clockwise (CW) based on the central axis of the first gear 510. However, this description is merely illustrative, and embodiments of the present disclosure are not limited thereto.

Referring to FIGS. 5 to 11, the sensor part 700 may be coupled onto the swivel structure 400 and generate gear measurement values for the seat support part 130. Here, the gear measurement values may generate gear measurement values including the rotation direction and rotation angle of the seat support part 130. To this end, the sensor part 700 may include a first sensor module 710 and a second sensor module 720.

The first sensor module 710 may be coupled to the upper swivel plate 410 and measure the rotation angle of the upper swivel plate 410. For example, the first sensor module 710 may be an encoder sensor, which, however, is merely an example, and may be any of sensors capable of measuring angles.

The second sensor module 720 may be coupled to the lower coupling plate 420 and measure a change in position of the first sensor module 710, thereby measuring the rotation direction of the upper swivel plate 410. The rotation direction may include whether the upper swivel plate 410 rotates. For example, if the first sensor module 710 is coupled onto the upper swivel plate 410 and is rotated, the first sensor module 710 may pass through a groove formed in the second sensor module 720. The second sensor module 720 may measure the rotation direction, including whether the first sensor module 710 rotates, based on the groove.

In addition, the second sensor module 720 may be disposed on the lower coupling plate 420 in at least one. The at least one second sensor module 720 may be disposed on the lower coupling plate 420 to be spaced apart from each other in correspondence to a preset distance. For example, the second sensor module 720 may be disposed based on the position at which the upper swivel plate 410 rotates per unit time based on the first gear 510 and the second gear 520. That is, the at least one second sensor module 720 may be disposed corresponding to at least one of the positions that allow the first sensor module 710, which is repositioned per unit time based on the rotation of the upper swivel plate 410, to be placed in the groove of the second sensor module 720. Through this, the second sensor module 720 can identify the rotation stop state of the upper swivel plate 410 to which the first sensor module 710 is coupled based on the fact that the first sensor module 710 is placed in the groove and stopped. In addition, the second sensor module 720 can identify the rotating state of the upper swivel plate 410 to which the first sensor module 710 is coupled based on the first sensor module 710 passing through the groove and moving. That is, the second sensor module 720 can identify whether the upper swivel plate 410 is rotating based on whether the first sensor module 710 moves through the groove of the second sensor module 720. Therefore, the sensor part 700 may generate gear measurement values including the rotation direction and rotation angle of the seat support part 130 that rotates in dependence on the rotation motion of the upper swivel plate 410.

Further, the sensor part 700 may measure the rotation direction of the seat support part 130 based on the first sensor module 710 passing through each groove of the plurality of second sensor modules 720 and being repositioned. For example, the sensor part 700 may measure the rotation direction of the upper swivel plate 410 to which the first sensor module 710 is coupled based on the sequence of the grooves of each second sensor module 720 through which the first sensor module 710 passes. If the plurality of second sensor modules 720 is coupled to the lower coupling plate 420, the first sensor module 710 can measure the rotation angle of the seat support part 130. Conversely, if one second sensor module 720 is coupled onto the lower coupling plate 420, the first sensor module 710 can measure the rotation angle and rotation direction of the seat support part 130. However, this description is merely illustrative, and embodiments of the present disclosure are not limited thereto. The description is simply illustrative, and embodiments of the present disclosure are not limited thereto.

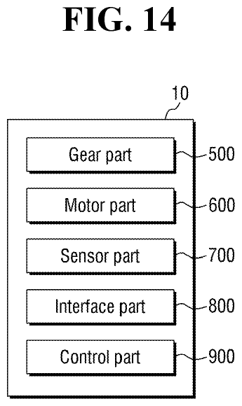

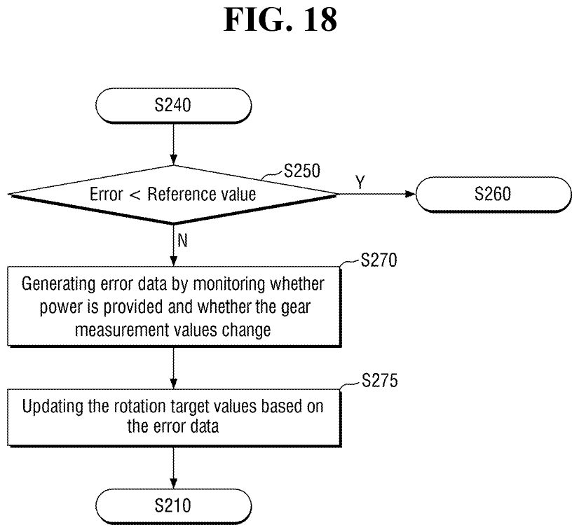

In the following, a method of controlling an automated swivel seat in accordance with some embodiments of the present disclosure will be described with reference to FIGS. 14 and 18.

FIG. 14 is a block diagram of an automated swivel seat for describing a method of controlling the automated swivel seat in accordance with some embodiments of the present disclosure.

Referring to FIG. 14, the automated swivel seat 10 may include a gear part 500, a motor part 600, a sensor part 700, an interface part 800, and a control part 900.

Referring to FIGS. 12 and 13 together, the gear part 500 may include a first gear 510 and a second gear 520.

The first gear 510 may be disposed in the first through hole h1 of the base part 200 and coupled to the upper swivel plate 410 of the swivel structure 400. Through this, the first gear 510 can rotate the upper swivel plate 410 as it rotates. Therefore, the upper swivel plate 410 of the swivel structure 400 may rotate in proportion to the number of revolutions of the first gear 510.

The second gear 520 may be disposed to mesh with the first gear 510 and provided with power from the motor part 600. At this time, the first gear 510 may move along the outer peripheral surface of the second gear 520.

The motor part 600 may include a motor that transmits power to the gear part 500. For example, the motor part 600 may be coupled to the second gear 520 by passing through the bracket 220 and transmit power to the second gear 520. At this time, the motor part 600 may be fixed to the base part 200 by passing through the bracket 220 that is fixed to the base part 200.

In addition, if the second gear 520 that has been provided with power rotates clockwise (CW) about the central axis of the second gear 520, the first gear 510 can rotate counterclockwise (CCW) based on the central axis of the first gear 510. On the contrary, if the second gear 520 rotates counterclockwise (CCW) about the central axis of the second gear 520, the first gear 510 can rotate clockwise (CW) based on the central axis of the first gear 510. However, this description is merely illustrative, and embodiments of the present disclosure are not limited thereto.

Meanwhile, referring to FIGS. 6 and 8 together, the sensor part 700 may be coupled onto the swivel structure 400 and monitor the rotation direction and rotation angle of the seat support part 130, thereby generating gear measurement values. The sensor part 700 may include a first sensor module 710 and a second sensor module 720. For example, the first sensor module 710 may be coupled to the upper swivel plate 410 of the swivel structure 400 and measure the rotation angle of the upper swivel plate 410. This can be viewed as the same as the first sensor module 710 being coupled to the upper swivel plate 410 and measuring the rotation angle of the seat support part 130 that is dependent on the rotation motion of the upper swivel plate 410. The first sensor module 710 may include a sensor capable of measuring the rotation angle of the seat support part 130 or measuring the rotation angle and rotation direction of the seat support part 130. However, this description is merely illustrative, and embodiments of the present disclosure are not limited thereto.

The second sensor module 720 may be coupled to the lower coupling plate 420 and fixed independently of whether the automated swivel seat 10 rotates. For example, the second sensor module 720 may be disposed on the lower coupling plate 420 based on a preset position and identify the first sensor module 710 that passes through the second sensor module 720, thereby measuring gear measurement values including the rotation direction and rotation angle of the upper swivel plate 410 to which the first sensor module 710 is coupled. The rotation direction of the upper swivel plate 410 that the second sensor module 720 measures may include whether the upper swivel plate 410 rotates. That is, the second sensor module 720 can measure gear measurement values of the seat support part 130 that rotates in dependence on the upper swivel plate 410.

The interface part 800 may include an interface capable of receiving the rotation direction and rotation angle of the automated swivel seat 10 installed inside the vehicle.

The interface part may receive user input entered via the interface. For example, an interface on which the range of swivelable angle of the seat is displayed may be provided to a user terminal. Through this, the user can enter rotation target values including a target rotation direction and a target rotation angle via the interface provided on the user terminal.

As another example, an interface on which preset angles are listed and displayed may be provided to the user terminal. Through this, the user can select one of the preset angles. The user terminal may generate the angle selected by the user as the target rotation angle. For example, the preset angles may include 45 degrees, 90 degrees, 135 degrees, 180 degrees, and 270 degrees. In addition, the preset angles may be arranged based on the position at which the upper swivel plate 410 rotates per unit time according to the operation of the first gear 510 and the second gear 520. Therefore, the preset angles may be determined according to the specifications of the first gear 510 and the second gear 520. However, this description is merely illustrative, and embodiments of the present disclosure are not limited thereto. Moreover, the preset angles may be set differently for each seat.

As yet another example, the interface may include a virtual image of a seat disposed in the vehicle. The user can touch and rotate the virtual image on the interface outputted to a display module of the user terminal. Accordingly, the user terminal may generate the rotation target value based on input including a user touch. At this time, the interface part 800 may display on the interface an expected reposition image of the seat to be rotated based on the rotation target value. For example, the user terminal may generate the rotation target value based on input including the preset angles and user touch. The rotation target value may be set in proportion to the number of inputs entered, and may be generated based on the product of the preset angles and the number of inputs. However, this description is merely illustrative, and embodiments of the present disclosure are not limited thereto.

The user terminal may be provided inside the vehicle, including the display module to be mounted in the vehicle. In addition, the user terminal may be a terminal of a user who uses the vehicle. However, this description is merely illustrative, and embodiments of the present disclosure are not limited thereto.

The control part 900 may control the rotation of the automated swivel seat 10 in conjunction with the gear part 500, motor part 600, sensor part 700, and interface part 800. For example, the control part 900 may control the operation of the motor part 600 by comparing the gear measurement values and the rotation target values.

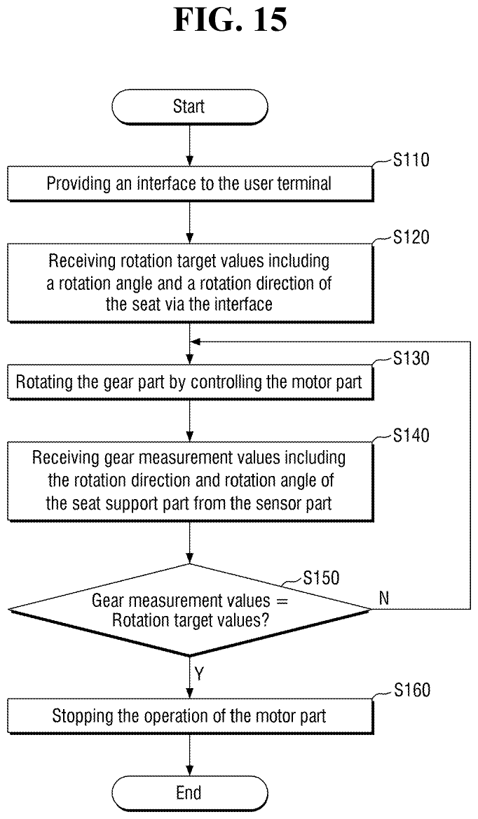

In the following, the operation of the control part 900 will be described together while describing a method of controlling the automated swivel seat with reference to FIGS. 15 to 18.

FIG. 15 is a flowchart for describing a method of controlling an automated swivel seat in accordance with a first embodiment of the present disclosure.

Referring to FIGS. 14 and 15, the automated swivel seat 10 may provide an interface to the user terminal at S110. For example, the control part 900 may provide the user terminal with an interface that can receive rotation target values in conjunction with the interface part 800.

Next, the control part 900 may receive the user input entered via the interface. Based on the user input, the control part 900 may derive rotation target values including a target rotation direction and a target rotation angle. For example, the control part 900 may derive the user input as the target rotation direction and the target rotation angle at S120.

Next, the control part 900 may rotate the gear part 500 by controlling the motor part 600 at S130. For example, the control part 900 may provide power to the second gear 520 by operating the motor part 600. The second gear 520 may mesh with the first gear 510 that is disposed in the first through hole h1 of the base part 200 and is coupled with the upper swivel plate 410. The base part 200 may be fixed onto the lower frame of the vehicle.

Through this, the first gear 510 may move along the outer peripheral surface of the second gear 520, and the upper swivel plate 410 of the swivel structure 400 may rotate in proportion to the number of revolutions of the first gear 510. At this time, the seat support part 130 fixed to the upper swivel plate 410 may rotate in dependence on the rotation motion of the upper swivel plate 410.

Next, the control part 900 may receive gear measurement values of the seat support part 130 from the sensor part 700 at S140. The gear measurement values may include the rotation direction and rotation angle of the upper swivel plate 410 that the sensor part 700 measures while being fixed to the swivel structure 400.

For example, referring to FIG. 13 together, the upper swivel plate 410 may rotate in the same direction as the rotation direction of the first gear 510 coupled to the upper swivel plate 410. The rotation direction of the first gear 510 may be opposite to the rotation direction of the second gear 520. Although the rotation direction of the first gear 510 shown in FIG. 13 is shown as counterclockwise (CCW), which is the direction opposite to the rotation direction of the second gear 520, the embodiment is not limited thereto. Therefore, if the second gear 520 rotates counterclockwise (CCW), the first gear 510 and the upper swivel plate 410 may be in the clockwise (CW) direction. However, this description is merely illustrative, and embodiments of the present disclosure are not limited thereto.

Referring again to FIGS. 14 and 15, next, the control part 900 may calculate whether the gear measurement values match the rotation target values at S150. For example, the control part 900 may calculate whether the rotation target direction and the rotation direction of the gear measurement values match.

As another example, the control part 900 may calculate whether the target rotation angle and the rotation angle of the gear measurement values match.

If the gear measurement values and the rotation target values do not match, the control part 900 may repeatedly perform steps S130 to S150.

Conversely, if the gear measurement values and the rotation target values match, the control part 900 may control the operation of the motor part 600. For example, the control part 900 may stop the operation of the motor part 600 and cut off the power provided to the gear part 500 at S160. Through this, the rotation of the seat support part 130 fixed to the upper swivel plate 410 of the swivel structure 400 may also be stopped. The rotation of the seat frame 100 fixed to the seat support part 130 may be stopped as well.

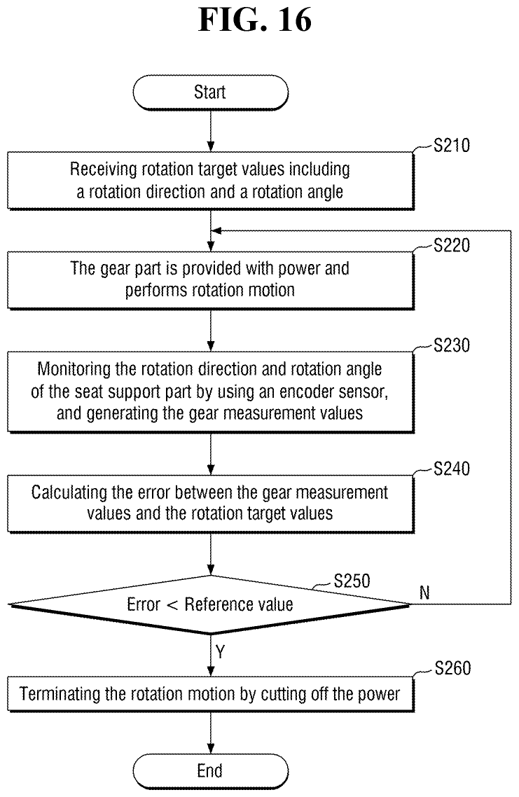

FIG. 16 is a flowchart for describing a method of controlling an automated swivel seat in accordance with a second embodiment of the present disclosure.

Referring to FIGS. 14 and 16, the control part 900 may receive rotation target values including a target rotation direction and a target rotation angle from the user terminal at S210.

Next, the control part 900 may provide power to the gear part 500 by controlling the motor part 600. Accordingly, the gear part 500 may be provided with power and rotate at S220. For example, the first gear 510 may rotate while moving along the outer peripheral surface of the second gear 520 with which it is meshed. At this time, the second gear 520 may rotate clockwise. However, this description is merely illustrative, and embodiments of the present disclosure are not limited thereto.

Next, the sensor part 700 may monitor the rotation direction and rotation angle of the seat support part 130 and measure the gear measurement values at S230. The generated gear measurement values may be provided to the control part 900. For example, referring to FIG. 8 together, the first sensor module 710 and the second sensor module 720 of the sensor part 700 may measure gear measurement values for the seat support part 130 by measuring the rotation direction and rotation angle of the upper swivel plate 410. Although FIG. 16 illustrates that an encoder sensor generates gear measurement values, embodiments of the present disclosure are not limited thereto. The gear measurement values for the seat support part 130 may be measured by a sensor capable of sensing at least one of the rotation angle, rotation direction, and whether it is operative.

Next, the control part 900 may calculate the error between the received gear measurement values and the rotation target values at S240. For example, the control part 900 may calculate an error, which is whether there is a discrepancy between the rotation direction of the gear measurement values and the target rotation direction of the rotation target values.

As another example, the control part 900 may calculate the error between the rotation angle of the gear measurement values and the target rotation angle of the rotation target values.

If the error is smaller than a reference value, the control part 900 may cut off the power by controlling the motor part 600. Accordingly, the rotation motion of the first gear 510, the second gear 520, the swivel structure 400, and the seat support part 130 may be terminated at S260.

The reference value is a preset reference value and may be a value that falls within an error tolerance range. However, this description is merely illustrative, and embodiments of the present disclosure are not limited thereto.

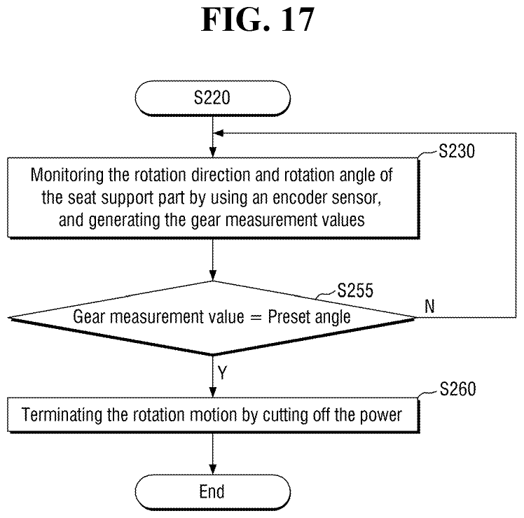

FIG. 17 is a flowchart for describing a method of controlling an automated swivel seat in accordance with a third embodiment of the present disclosure.

Referring to FIGS. 14 and 17, if the second gear 520 is provided with power and operates at S220, the sensor part 700 may monitor the rotation direction and rotation angle of the upper swivel plate 410 and measure the gear measurement values of the seat support part 130 at S230. Although FIG. 17 illustrates that an encoder sensor generates gear measurement values, embodiments of the present disclosure are not limited thereto. The gear measurement values for the seat support part 130 may be measured by a sensor capable of sensing at least one of the rotation angle, rotation direction, and whether it is operative.

Next, the control part 900 may calculate whether the gear measurement value and the preset angle match. Here, the preset angle may be a user input entered via the interface part 800. For example, it may be any one selected by the user out of the preset angles displayed on the interface. The preset angles may be any of 45 degrees, 90 degrees, 135 degrees, 180 degrees, and 270 degrees.

In addition, referring to FIGS. 6 and 8 together, the preset angles may be arranged based on the position at which the upper swivel plate 410 rotates per unit time according to the operation of the first gear 510 and the second gear 520. Therefore, the preset angles may be determined according to the specifications of the first gear 510 and the second gear 520. However, this description is merely illustrative, and embodiments of the present disclosure are not limited thereto. Moreover, the preset angles may be set differently for each seat.

That is, the control part 900 may calculate whether the gear measurement value and the preset angle, which is the rotation target value, match. The rotation target value may be received from the user terminal or set in proportion to the preset angle. For example, the rotation target value may be determined based on at least one value that is preset so that the first sensor module 710 is disposed in correspondence to one of the second sensor modules 720. However, this description is merely illustrative, and embodiments of the present disclosure are not limited thereto.

Next, if the gear measurement value and the preset angle do not match, steps S230 and S255 may be performed repeatedly.

If the gear measurement value and the preset angle match, the control part 900 may terminate the rotation motion of the second gear 520 and the seat support part 130 by cutting off the power at S260.

FIG. 18 is a flowchart for describing a method of controlling an automated swivel seat in accordance with a fourth embodiment of the present disclosure.

Referring to FIGS. 14 and 18, the control part 900 may calculate the error between the gear measurement values and the rotation target values at S240.

If the calculated error is smaller than a reference value, the control part 900 may terminate the rotation motion of the second gear 520 and the seat support part 130 by stopping the operation of the motor part 600 at S260.

If the error is greater than or equal to the reference value, the control part 900 may generate error data by monitoring whether power is provided and whether the gear measurement values change at S270. For example, the control part 900 may monitor whether the motor part 600 is operating or whether the seat support part 130 is rotating.

If the seat support part 130 is rotated by the operation of the motor part 600, the control part 900 may calculate whether the gear measurement values change. If the gear measurement values do not change while power is supplied to the second gear 520, the control part 900 may generate first error data. The first error data may be error data that provides the user terminal with an indication that the automated swivel seat is in a situation of being unable to rotate.

Next, the control part 900 may update the rotation target values based on the first error data. For example, the control part 900 may update the rotation target values based on a first gear measurement value, which is the gear measurement value at the time the first error data is generated.

The target rotation direction of the rotation target values to be updated may be opposite to the rotation direction of the first gear measurement value. At this time, the target rotation angle of the rotation target values to be updated may be a value obtained by excluding the rotation angle of the existing rotation target values from the sum of the angle of the first gear measurement value and 360 degrees. However, this description is merely illustrative, and embodiments of the present disclosure are not limited thereto.

In addition, the target rotation angle to be updated may be an angle for the automated swivel seat 10 to return to the arrangement prior to performing rotation motion based on the first gear measurement value. That is, the target rotation angle to be updated may be the rotation angle of the first gear measurement value. However, this description is merely illustrative, and embodiments of the present disclosure are not limited thereto.

Next, the automated swivel seat 10 may rotate based on the updated rotation target values.

Additionally, the error data may include second error data corresponding to a failure of the automated swivel seat 10.

For example, when the motor part 600 provides power to the second gear 520 and the seat support part 130 rotates, the control part 900 may calculate whether the gear measurement values change. If power is provided to the second gear 520 but the gear measurement values do not change, the control part 900 may generate second error data. The second error data may be error data that requests an inspection of the automated swivel seat 10.

Next, the automated swivel seat 10 may initialize the rotation target value to a preset angle based on the second error data. The preset angle may be an angle that is set for each seat. Further, the preset angle may correspond to ‘0’ for stopping the rotation motion. However, this description is merely illustrative, and embodiments of the present disclosure are not limited thereto.

In addition, the error data may include third error data corresponding to the gear part 500 and sensor part 700 of the automated swivel seat 10. For example, when the motor part 600 provides power to the second gear 520 and the seat support part 130 is rotated and repositioned, the control part 900 may generate third error data based on whether the first sensor module 710 is disposed in the groove of the second sensor module 720. Specifically, if the first sensor module 710 is not disposed in the groove of the second sensor module 720, the control part 900 may generate third error data corresponding to the motor part 600 and the sensor part 700. The third error data may include data indicating that the motor part 600 and the sensor part 700 need repair and replacement. For example, the third error data may include data indicating that the first gear 610 and the second gear 620 of the motor part 600 need repair and replacement, and data indicating that the first sensor module 710 and the second sensor module 720 of the sensor part 700 need repair and replacement. However, this description is merely illustrative, and embodiments of the present disclosure are not limited thereto.

Accordingly, the automated swivel seat and the method for controlling the same in accordance with some embodiments of the present disclosure can increase the utilization of space inside the vehicle by allowing the rotation direction of the seat to be freely adjusted inside the vehicle.

In addition, the present disclosure can be easily installed on an existing vehicle frame without being limited to placement within a vehicle and can be applied to other fields besides vehicles, thereby having high versatility by being able to be installed on the guide rails fixed to the vehicle lower frame or on the vehicle lower frame.

Further, the present disclosure can be highly scalable for seat placement by allowing a seat to be rotated automatically about the central axis at the corresponding position even if the seat is repositioned along the guide rails, and utilizability that a user utilizes the space inside the vehicle can be improved through the reposition of the seats within the vehicle.

Moreover, the present disclosure can provide the user with the convenience of being able to freely adjust the rotation direction of the seat intuitively inside the vehicle by providing the user with a control scheme that corresponds to a common user experience and a logical way of thinking with which the user repositions the vehicle seats.

Furthermore, the present disclosure can provide the user with the convenience of repositioning the seat by repositioning the seat to reach the rotation target values by controlling the power.

In addition, the present disclosure can provide the user with the convenience of repositioning the seat by providing the user with an interface through which the rotation target values can be inputted. Further, the present disclosure can provide convenience in vehicle maintenance by providing the user with errors detected by monitoring the rotation of the automated swivel seat. Moreover, by controlling the operation of the automated swivel seat based on the detected errors, it is possible to prevent phenomena that errors occur in the seat operation or of non-rotation.

Furthermore, the present disclosure can provide the user with a sense of stability according to use as noises caused by seat rotation are reduced, power transmission and load are distributed as the contact areas of the gears for seat rotation are enlarged and the efficiency of the gears is increased, thereby extending the product life cycle of the gears, and maintenance costs associated therewith can be reduced.

The above description is merely an illustrative description of the technical idea of the present embodiments, and those of ordinary skill in the art to which the present embodiments pertain will be able to make various modifications and variations without departing from the essential characteristics of the present embodiments. Therefore, the present embodiments are not intended to limit the technical idea of the embodiments but to illustrate, and the scope of the technical idea of the present embodiments is not limited by such embodiments. The scope of protection of the present embodiments should be interpreted according to the claims below, and all technical ideas within the equivalent scope should be construed as falling within the scope of rights of the embodiments.

While the inventive concept has been particularly shown and described with reference to exemplary embodiments thereof, it will be understood by those of ordinary skill in the art that various changes in form and details may be made therein without departing from the spirit and scope of the inventive concept as defined by the following claims. It is therefore desired that the embodiments be considered in all respects as illustrative and not restrictive, reference being made to the appended claims rather than the foregoing description to indicate the scope of the disclosure.

What is claimed is:

1. An automated swivel seat configured to be installed inside a vehicle, comprising:
a base part fixed to a lower frame of the vehicle and comprising a first through hole formed in a central part thereof;
a seat support part fixed to a lower side of a seat frame and configured to rotate on the base part;
a swivel structure disposed between the base part and the seat support part and comprising an upper swivel plate coupled to the seat support part and a lower coupling plate coupled to the base part;
a first gear disposed in the first through hole and coupled to one side of the upper swivel plate;
a second gear engage with the first gear;
a motor part fixed to the base part, and coupled to the second gear and configured to provide power to the second gear;
a sensor part coupled onto the swivel structure and configured to generate gear measurement values comprising a rotation direction and a rotation angle of the seat support part; and
a control part configured to control operation of the motor part by comparing the gear measurement values and rotation target values.

2. The automated swivel seat of claim 1, wherein the first gear moves along an outer peripheral surface of the second gear as the motor part operates, and
the upper swivel plate rotates in proportion to the number of revolutions of the first gear.

3. The automated swivel seat of claim 2, wherein the first gear has one side thereof formed to engage with the outer peripheral surface of the second gear, and a stepped part formed so that the other side thereof passes through the first through hole.

4. The automated swivel seat of claim 2, wherein the sensor part comprises:
a first sensor module coupled to the upper swivel plate and configured to measure the rotation angle of the upper swivel plate; and
at least one second sensor module coupled to the lower coupling plate and configured to measure the rotation direction of the upper swivel plate by measuring a change in position of the first sensor module.

5. The automated swivel seat of claim 4, wherein the rotation target values are determined based on at least one value that is preset so that the first sensor module is disposed in correspondence to one of the second sensor modules.

6. The automated swivel seat of claim 1, wherein the control part calculates an error between the gear measurement values and the rotation target values, and controls the operation of the motor part based on a difference between the error and a preset reference value.

7. The automated swivel seat of claim 6, wherein the control part comprises:
generating error data based on whether the gear measurement values change and whether the power is provided if the error is greater than the preset reference value; and
updating the rotation target values based on the error data.

8. The automated swivel seat of claim 6, wherein the rotation target values are determined by user input entered via an interface part.

9. The automated swivel seat of claim 1, further comprising:
a guide rail part coupled to the lower frame;
a sliding part configured to slide on the guide rail part; and
a sliding structure comprising a sliding motor part coupled to the guide rail part and configured to provide power to the sliding part,
wherein the base part is coupled to the sliding part.

10. A method of controlling the automated swivel seat of claim 1 performed by a control part disposed inside a vehicle, the method of controlling a swivel seat comprising:
receiving user input entered via an interface part that is linked with the control part;
deriving rotation target values comprising a target rotation direction and a target rotation angle based on the user input;
operating a motor part configured to provide power to a second gear engage with a first gear fixed onto a seat support part, wherein the seat support part is fixed to a seat frame;
measuring a rotation direction and a rotation angle of the seat support part by a sensor part, and receiving gear measurement values comprising the measured rotation direction and rotation angle; and
controlling operation of the motor part based on the gear measurement values and the rotation target values.

11. The method of controlling a swivel seat of claim 10, wherein the controlling the operation of the motor part comprises:
calculating an error between the gear measurement values and the rotation target values; and
stopping the operation of the motor part if the error is smaller than a preset reference value.

12. The method of controlling a swivel seat of claim 11, wherein the controlling the operation of the motor part further comprises:
generating error data based on whether the gear measurement values change and whether the power is provided if the error is greater than the preset reference value; and
updating the rotation target values based on the error data.
